(19) United States
(12) Patent Application Publication
(10) Pub. No.: US 2020/0246992 A1
(43) Pub. Date: Aug. 6, 2020

(54) Knife Grip Attachment

(71) Applicant: Peter Ritter, Tampa, FL (US)

(72) Inventor: Peter Ritter, Tampa, FL (US)

(21) Appl. No.: 16/782,238

(22) Filed: Feb. 5, 2020

Related U.S. Application Data
(60) Provisional application No. 62/801,162, filed on Feb. 5, 2019.

(51) Int. Cl. B26B 29/02; B26B 3/00

(52) U.S. Cl. CPC B26B 29/02; B26B 3/00

(57) ABSTRACT

A knife grip attachment. The attachment includes a body having an upper portion and a pair of lateral portions extending therefrom. A recess is defined within the body between the pair of lateral portions, wherein the recess receives a spine of a knife blade therein, such that a lower surface of the upper portion rests against the spine. In some embodiments, a protrusion extends from a rear side of the upper portion, wherein the protrusion extends over a knife handle when the spine is received within the recess.

### CROSS REFERENCE TO RELATED APPLICATIONS

This application claims the benefit of U.S. Provisional Application No. 62/801,162 filed on Feb. 5, 2019. The above identified patent application is herein incorporated by reference in its entirety to provide continuity of disclosure.

### BACKGROUND OF THE INVENTION

The present invention relates to knife grip attachments. More particularly, the present invention pertains to a knife grip attachment having a recess between a pair of lateral portions configured to receive a spine of a knife blade therein, such that the spine is cushioned to increase user comfort.

Many people frequently utilize knives when cooking to properly prepare ingredients in a desired fashion. A typical grip for handling a chef's knife when cooking is known as a pinch grip. With this grip, the user places their thumb and index finger on opposite sides of the knife blade just above the bolster, while the remaining fingers are wrapped around the handle of the knife. This grip provides the user with greater control than a grip where each finger is wrapped around the handle. However, when using a pinch grip, the upper portion of the user's index finger presses against the spine of the knife blade, which can cause discomfort or injury over extended periods of knifework. Some such injuries include calluses, blisters, and pain caused from pinched nerves and pressure points, which often require a user to take frequent breaks when preparing food. Therefore, there is need for a device that can secure to a knife that alleviates discomfort when using a knife in a pinch grip over long periods of time.

In light of the devices disclosed in the known art, it is submitted that the present invention substantially diverges in design elements from the known art and consequently, it is clear that there is a need in the art for an improvement to existing knife grip attachments. In this regard, the instant invention substantially fulfills these needs.

### SUMMARY OF THE INVENTION

In view of the foregoing disadvantages inherent in the known types of knife grip attachments now present in the known art, the present invention provides a knife grip attachment wherein the same can be utilized for providing convenience and comfort for the user when gripping a knife in a traditional pinch grip.

The present system comprises a body having an upper portion and a pair of lateral portions extending therefrom. A recess is defined within the body between the pair of lateral portions, wherein the recess is configured to receive a spine of a knife blade therein, such that the upper portion rests against the spine. In some embodiments, an upper surface of the upper portion is rounded to provide additional comfort and to better conform to the user's hand in a pinch grip.

In another embodiment, a protrusion extends from a rear side of the upper portion, such that the protrusion is configured to extend over a knife handle when the body is secured to a knife blade. This provides additional cushioning to the user's hand along the knife handle. In some such embodiments, the protrusion is arcuate to envelop the knife handle. In another embodiment, the protrusion is defined by a pair of cutouts disposed through the pair of lateral portions, wherein the pair of cutouts are configured to receive a bolster of a knife blade therein. In this manner, the body securely fits around existing knife blade elements.

In another embodiment, the recess tapers from an upper side thereof towards a lower side thereof, such that a linear distance between the pair of lateral portions is greater at the upper side than at the lower side. In this manner, the recess is angled to provide increased frictional engagement with the knife blade to prevent slippage during use. In some embodiments, the upper side of the recess is angled to provide the tapering shape and better receive the spine of the knife blade therein. In some such embodiments, the upper side of the recess defines a 120-degree angle.

In other embodiments, a lower edge of the pair of lateral portions is arcuate, such that a height of the pair of lateral portions is greater at a midpoint thereof than at each opposing end of the pair of lateral portions, such that the height tapers towards each opposing end. In this manner, the user is provided with a curved gripping surface to conform to the contours of a user's index finger when gripping a knife blade.

In yet another embodiment, the body is flexible about the upper portion, such that a linear distance between the pair of lateral portions is adjustable to allow the body to removably secure to a variety of knife blade sizes. In some such embodiments, the pair of lateral portions are biased inwardly towards the recess to ensure maximal frictional engagement with the knife blade. In another embodiment, an interior surface of the pair of lateral sides comprises a textured surface thereon, such that additional frictional engagement with the knife blade is provided thereby.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of an embodiment of the knife grip attachment.

FIG. 1B shows a perspective view of an alternate embodiment of the knife grip attachment.

FIG. 2 shows a front view of an embodiment of the knife grip attachment.

FIG. 3 shows a side view of an embodiment of the knife grip attachment.

FIG. 4 shows an exploded view of an embodiment of the knife grip attachment over a knife.

### DETAILED DESCRIPTION OF THE INVENTION

Reference is made herein to the attached drawings. Like reference numerals are used throughout the drawings to depict like or similar elements of the knife grip attachment. The figures are intended for representative purposes only and should not be considered to be limiting in any respect.

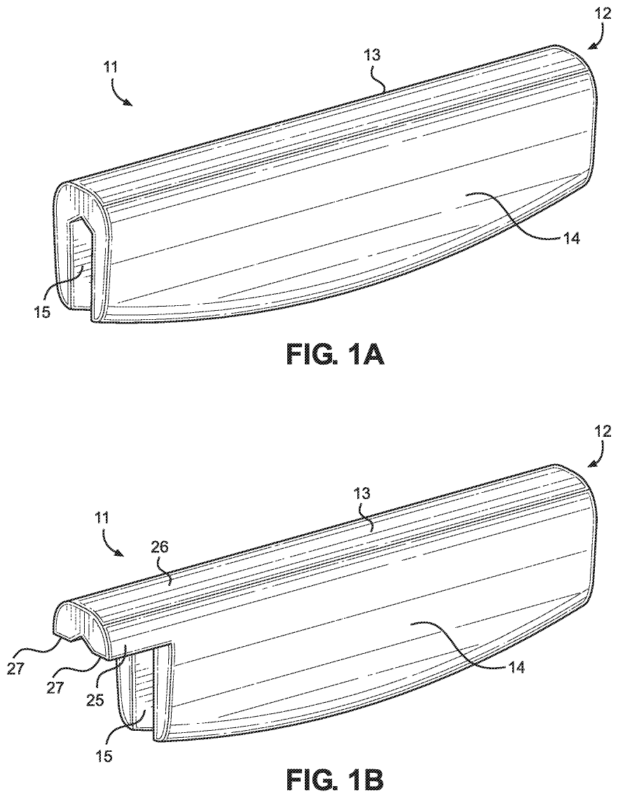

Referring now to FIGS. 1A and 1B, there are shown perspective views of various embodiments of the knife grip attachment. The knife grip attachment 11 comprises a body 12 having an upper portion 13 and a pair of lateral portions 14 extending therefrom. A recess 15 is defined within the body 12 between the pair of lateral portions 14 and is configured to receive a spine of a knife blade therein. In some embodiments, the body 12 comprises a flexible material configured to flex about the upper portion 13, such that the body 12 can removably secure about knife blades of varying sizes and thicknesses. It is contemplated that the body 12 can comprise a variety of materials having such flexible and durable properties, including, but not limited to, thermoplastic elastomers, food grade silicone, or the like. In some embodiments comprising a thermoplastic elastomer, the body 12 is configured to constrict about a knife blade when heat is applied thereto, such as via submersing the body 12 within boiling water, such that the body 12 secures about a knife blade. Alternatively, in other embodiments, the knife grip attachment 11 is secured to a knife blade via pressure applied inwardly, towards the recess 15, when the user is gripping the knife. In yet another embodiment, the pair of lateral sides 14 are inwardly biased towards the recess 15, such that the pair of lateral sides 14 frictionally engage opposing sides of the knife blade when the knife grip attachment 11 is placed on a knife blade.

In some embodiments, the body 12 further comprises a compressible material, such that the knife grip attachment 11 provides a cushioned gripping surface to the user. In the illustrated embodiments, the upper portion 13 comprises a rounded shape to provide comfort to the user when gripped.

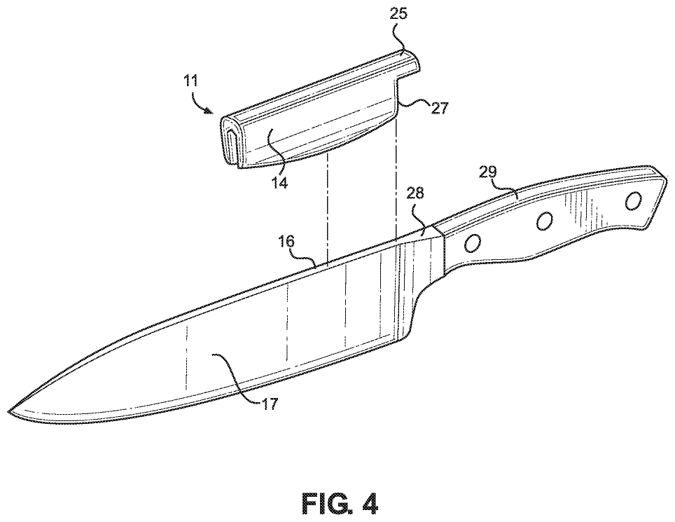

In the illustrated embodiment of FIG. 1B, the knife grip attachment 11 further comprises a protrusion 25 extending from a rear side 26 of the upper portion 13. The protrusion 25 includes an interior hollow channel configured to receive a bolster (as shown in FIG. 4, 28) and a handle (as shown in FIG. 4, 29) of a knife therein, such that the protrusion 25 secures about the bolster and handle to provide additional securement. In the illustrated embodiment, the protrusion 25 is defined by a pair of cutouts 27 disposed through the pair of lateral portions 14, wherein the pair of cutouts 27 are configured to receive the bolster of the knife therein. In this manner, the knife grip attachment 11 is configured to secure about existing elements of a knife blade, such as the bolster, without causing the recess 15 to bow outwards, thereby reducing adhesion to the knife blade via frictional engagement. In some embodiments, the protrusion 25 is arcuate to provide a rounded outer surface for user comfort. In additional embodiments, the protrusion 25 is flexible such that the protrusion 25 can conform to the shape of a variety of knife handles and bolsters.

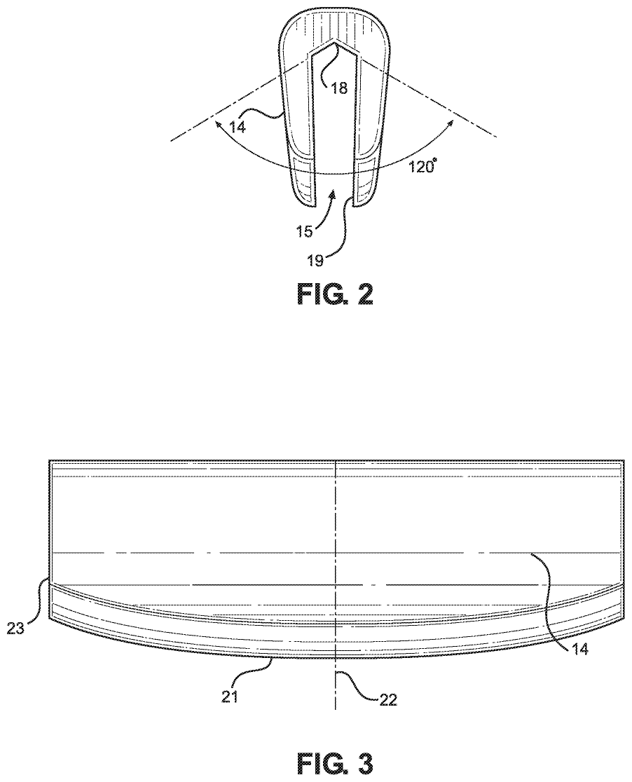

Referring now to FIG. 2, there is shown a front view of an embodiment of the knife grip attachment. In the illustrated embodiment, the recess 15 is defined between the pair of lateral portions 14 such that the recess 15 is configured to conform to the shape of a knife blade. In some embodiments, an interior surface of each of the pair of lateral portions 14 comprises textured elements thereon, such that frictional engagement with the knife blade is increased. Various forms of textured elements that increase surface area in contact with the knife blade are contemplated, such as, but not limited to, rounded protrusions, pyramidal protrusions, crosshatch protrusions, and the like.

The recess 15 comprises an upper side 18 opposite a lower side 19. In the illustrated embodiment, the recess 15 tapers inwardly from the upper side 18 towards the lower side 19, such that a linear distance between each of the pair of lateral portions 14 is greater at the upper side 18 than at the lower side 19. In this manner, the recess 15 can securely adhere to a knife blade inserted therein as the lower side 19 is ensured to frictionally engage each side of the knife blade. In the shown embodiment, the upper side 18 comprises an angled shape, such that the spine of the knife blade is readily received therein, allowing the upper portion to flex about the spine within the angled portion of the upper side 18. In this manner, the spine is frictionally secured within the upper side 18, thereby minimizing the risk of the body sliding along a length of the knife blade when in use. In some embodiments, the angle comprises a 120-degree angle. In some embodiments having a protrusion as previously described, the hollow of the protrusion is aligned and continuous with the recess 15, such that a cross-section of the hollow is defined by a cross-section of the recess 15. In this way, the protrusion and the recess 15 are uniform along a length of the body, such that the protrusion and the recess 15 are configured to flex in a similar manner when placed on a knife blade.

Referring now to FIG. 3, there is shown a side view of an embodiment of the knife grip attachment. In the illustrated embodiment, each of the pair of lateral portions 14 comprises an arcuate lower edge 21, such that the lower edge 21 provides a comfortable gripping surface against which a user can rest a curved index finger, as typically used in a pinch grip. In the shown embodiment, a height of the pair of lateral portions 14 is greatest at a midpoint 22 thereof, and further tapers from the midpoint towards each of the opposing ends 23 of the pair of lateral portions 14. This tapering results in an arcuate lower edge 21 that provides a guide for the index finger of the user, such that a proper pinch grip technique is utilized. In some embodiments, the lower edge 21 further tapers inwardly towards the recess, such that the lower edge 21 is rounded, providing additional comfort to the user.

Referring now to FIG. 4, there is shown an exploded view of an embodiment of the knife grip attachment over a knife. The knife grip attachment 11 secures over the spine 16 of the knife blade 17 such that the spine 16 is received within the recess of the body and the upper portion of the body rests against the spine 16. The pair of lateral portions 14 extend over opposing sides of the knife blade 17 above the cutting edge providing a gripping surface for the user. In the shown embodiment, the protrusion 25 extends from the rear side of the upper portion to rest over the bolster 28 and handle 29 of the knife. In this manner, the user's palm is cushioned against the protrusion 25 when the knife is in use. The pair of cutouts 27 disposed through the pair of lateral sides 14 receive the bolster 28 therein, such that the pair of lateral sides 14 are not forced outwards over the bolster 28. In this way, the pair of lateral sides 14 are in full contact with the knife blade 17 along an entire length thereof, thereby ensuring maximal frictional engagement with the knife blade 17. In the shown embodiment, the pair of cutouts 27 define a wall that is configured to abut the bolster 28 when the body is secured on the knife blade 17. In this manner, the knife grip attachment 11 is secured to the knife.

In one exemplary use, the user secures the body over the knife blade 17 such that the spine 16 is received within the recess such that the upper portion rests against the spine 16 and the pair of lateral sides 14 extend over the sides of the knife blade 17. In embodiments with a protrusion 25, the protrusion 25 is secured over the bolster 28 and the handle 29, such that the pair of cutouts 27 receive the bolster 28 therein. The user can then grip the knife in a pinch grip such that the index finger extends over the body and curves along the pair of lateral portions 14, and the thumb presses against the opposing lateral portion 14. The remaining three fingers can be wrapped about the handle 29. In this manner, the upper end of the user's index finger is cushioned against the spine 16 by the upper portion of the body, ensuring that pain and discomfort from the spine 16 digging into the index finger is minimized, thereby allowing the user to comfortably use the knife over longer periods of time.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A knife grip attachment, comprising:
a body having an upper portion and a pair of lateral portions extending therefrom;
a recess defined within the body between the pair of lateral portions;
wherein the recess is configured to receive a spine of a knife blade therein, such that the upper portion rests against the spine.

2. The knife grip attachment of claim 1, wherein the upper portion is rounded.

3. The knife grip attachment of claim 1, wherein the recess tapers from an upper side thereof towards a lower side thereof, such that a linear distance between the pair of lateral portions is greater at the upper side than at the lower side.

4. The knife grip attachment of claim 3, wherein the upper side of the recess is angled.

5. The knife grip attachment of claim 4, wherein the upper side of the recess defines a 120-degree angle.

6. The knife grip attachment of claim 1, wherein a lower edge of the pair of lateral portions is arcuate, such that a height of the pair of lateral portions is greater at a midpoint thereof than at each opposing end thereof, such that the lower edge tapers from the midpoint towards each opposing end.

7. The knife grip attachment of claim 1, wherein the body is flexible, such that a linear distance between the pair of lateral portions is adjustable.

8. The knife grip attachment of claim 7, wherein the pair of lateral portions are biased inwardly towards the recess.

9. A knife grip attachment, comprising:
a body having an upper portion and a pair of lateral portions extending therefrom;
a recess defined within the body between the pair of lateral portions;
wherein the recess is configured to receive a spine of a knife blade therein, such that the upper portion rests against the spine;
a protrusion extending from a rear side of the upper portion;
wherein the protrusion is configured to extend over a knife handle.

10. The knife grip attachment of claim 9, wherein the upper portion is rounded.

11. The knife grip attachment of claim 9, wherein the recess tapers from an upper side thereof towards a lower side thereof, such that a linear distance between the pair of lateral portions is greater at the upper side than at the lower side.

12. The knife grip attachment of claim 11, wherein the upper side of the recess is angled.

13. The knife grip attachment of claim 12, wherein the upper side of the recess defines a 120-degree angle.

14. The knife grip attachment of claim 9, wherein a lower edge of the pair of lateral portions is arcuate, such that a height of the pair of lateral portions is greater at a midpoint thereof than at each opposing end thereof, such that the lower edge tapers from the midpoint towards each opposing end.

15. The knife grip attachment of claim 9, wherein the body is flexible, such that a linear distance between the pair of lateral portions is adjustable.

16. The knife grip attachment of claim 15, wherein the pair of lateral portions are biased inwardly towards the recess.

17. The knife grip attachment of claim 9, wherein the protrusion comprises an arcuate shape.

18. The knife grip attachment of claim 9, wherein the protrusion is defined by a pair of cutouts through the pair of lateral portions, the pair of cutouts configured to receive a bolster of a knife blade therein.

19. The knife grip attachment of claim 18, wherein a wall of the pair of cutouts abuts the bolster when the body is secured over the knife blade.

20. The knife grip attachment of claim 9, wherein the recess and a hollow of the protrusion are aligned, such that a cross-section of the hollow is defined by the recess.
